(19) United States
(12) Patent Application Publication
(10) Pub. No.: US 2009/0321193 A1
(43) Pub. Date: Dec. 31, 2009

(54) BRAKE

(76) Inventors: Thomas Richard Jackman, Palmerston North (NZ); Jayson Leslie Puklowski, Palmerston North (NZ)

Correspondence Address: HARNESS, DICKEY, & PIERCE, P.L.C, 7700 Bonhomme, Suite 400, ST. LOUIS, MO, 63105, US

(21) Appl. No.: 12/491,935

(22) Filed: Jun. 25, 2009

Related U.S. Application Data
(60) Provisional application No. 61/075,739, filed on Jun. 25, 2008.

(51) Int. Cl. B60T 1/04

(52) U.S. Cl. 188/29

(57) ABSTRACT

Disclosed herein are various embodiments of brakes for non-motorized mobile apparatus and brakes for transport apparatus such as non-motorized scooters. In an exemplary embodiment, a brake assembly for a non-motorized mobile apparatus may generally include one or more wheel assemblies. A housing may be mounted on an upper surface of at least a portion of the mobile apparatus, adjacent the one or each wheel assemblies. One or each housing may be adapted to support a rotatable braking means or device, which, in turn, may include a biasing device or biasing means adjacent at least one wheel. In a first position, the rotatable braking means may be biased away from the at least one wheel. In a second position, the rotatable braking means may be biased to engage a surface of at least one wheel to slow or stop the mobile apparatus.

### CROSS-REFERENCE TO RELATED APPLICATION

This application claims the benefit of U.S. Provisional Application No. 61/075,739, filed on Jun. 25, 2008. The entire disclosure of the above application is incorporated herein by reference.

### FIELD

The present disclosure generally relates to improvements in and relating to brakes for non-motorized mobile apparatus and more particularly, but not exclusively, to brakes for transport apparatus such as non-motorized scooters. The brake is also suitable for trolleys for material handling, for example in the agricultural and horticultural field, disabled and elderly mobility carriers, prams, children's ride-on toys, transporters, mowers, and the like. For simplicity, the disclosure will be described in relation to a brake for a non-motorized scooter, but it is to be understood that a brake for other types of mobile apparatus is envisaged to be within the applications to which the present disclosure could be put and the term “mobile apparatus” is to be understood to have that broad meaning.

### BACKGROUND

This section provides background information related to the present disclosure which is not necessarily prior art.

Various brakes suitable for slowing or stopping a scooter are known. In many situations, there is a need for a scooter brake that is safe, easy to use, and inexpensive to produce.

In one known example, U.S. Pat. No. 6,352,270, a scooter brake is disclosed in which the brake assembly is pivotally mounted to the rear end of a scooter. In use, when the brake pedal is depressed, two auxiliary wheels linked to the braking system contact the ground to increase friction to stop the scooter. A disadvantage of this brake system is that it is complex to assemble because of the many component parts.

In another known example, U.S. Pat. No. 6,296,082, a scooter brake is disclosed in which the brake assembly includes a brake block and brake shoe mounted on top of the rear wheel cover of a scooter. Whilst this is an adequate system, the number of component parts adds to the production costs of the scooter.

As disclosed herein, the present disclosure provides various embodiments of a brake for a scooter, which may help overcome or ameliorate disadvantages in brakes for scooters available at the present time or which will at least provide a useful alternative.

### SUMMARY

This section provides a general summary of the disclosure, and is not a comprehensive disclosure of its full scope or all of its features.

According to an aspect of the disclosure, there are provided various exemplary embodiments of a brake assembly for a non-motorized mobile apparatus. The brake assembly may generally include one or more wheel assemblies. A housing may be mounted on an upper surface of at least a portion of the mobile apparatus, adjacent the one or each wheel assemblies. One or each housing may be adapted to support a rotatable braking means or device, which, in turn, may include a biasing device or biasing means adjacent at least one wheel. In a first position, the rotatable braking means may be biased away from the at least one wheel. In a second position, the rotatable braking means may be biased to engage a surface of at least one wheel to slow or stop the mobile apparatus.

In various embodiments, the brake assembly may be for a non-motorized scooter.

In various embodiments, the housing may be positioned above the top of a deck of a scooter.

In various embodiments, a body of the rotatable braking means may be positioned substantially over a top portion of a wheel.

In various embodiments, the housing may be attached to the top surface of a scooter deck by screwing means.

In various embodiments, the housing may include a U-shaped slot.

In various embodiments, the rotatable braking means may be attached to the housing by pivoting means.

In various embodiments, the rotatable braking means may be arcuate in shape.

In various embodiments, the rotatable braking means may be in the shape of a substantially semi-circular mud guard.

In various embodiments, a pivoting means may be provided in the form of a pivot pin or axle.

In various embodiments, the pivoting means may be biased across the U-shaped slot of the housing.

In various embodiments, the biasing means may be fixedly attached to the pivoting means.

In various embodiments, the biasing means may abut the rotatable braking means to urge the rotatable braking means away from a rim or edge of a wheel.

In various embodiments, the biasing means may be a spring or an elastic member.

In various embodiments, the biasing means may be a torsion spring.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a general perspective view of a scooter with the brake according to one embodiment of the present disclosure.

FIG. 2 shows a general sectional side view of a scooter with the brake according to the embodiment shown in FIG. 1.

FIG. 2a shows a plan view of the scooter showing the wheel assembly, with the brake assembly shown in dashed outline according to the embodiment of FIG. 1.

FIG. 3 shows a perspective view of the brake according to the embodiment shown in FIG. 1.

FIG. 4 shows a sectional view of the brake according to the embodiment shown in FIG. 1 showing the brake in operation.

FIG. 5 shows a sectional side view of the brake according to the embodiment shown in FIG. 1.

FIG. 6 shows a side view of the brake of according to the embodiment shown in FIG. 1 showing the brake in use.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

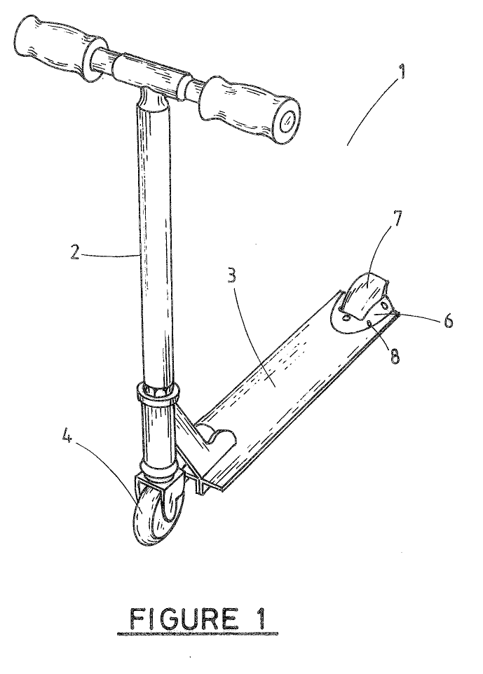

As disclosed herein, the present disclosure provides a vehicle braking arrangement. In the embodiment shown in FIGS. 1 through 6, the vehicle is a non-motorized scooter. But aspects of the present disclosure should not be limited only to use with non-motorized scooters, as embodiments disclosed herein may be suitable for trolleys for material handling, for example in the agricultural and horticultural field, disabled and elderly mobility carriers, prams, childrens' ride-on toys, transporters, mowers, and the like. For simplicity, the disclosure will be described in relation to a brake for a non-motorized scooter, but it is to be understood that a brake for other types of mobile apparatus is envisaged to be within the applications to which the present disclosure could be put and the term “mobile apparatus” is to be understood to have that broad meaning.

With reference now to the figures, FIG. 1 generally shows a scooter 1. The scooter 1 is of any generally known type, having a steering arrangement 2, a deck 3, and front and rear wheels 4, 5.

A brake housing 6 is shown attached to the rear of the deck 3. A wheel cover 7 is also shown which in FIG. 1, prevents the rear wheel 5 from being visible.

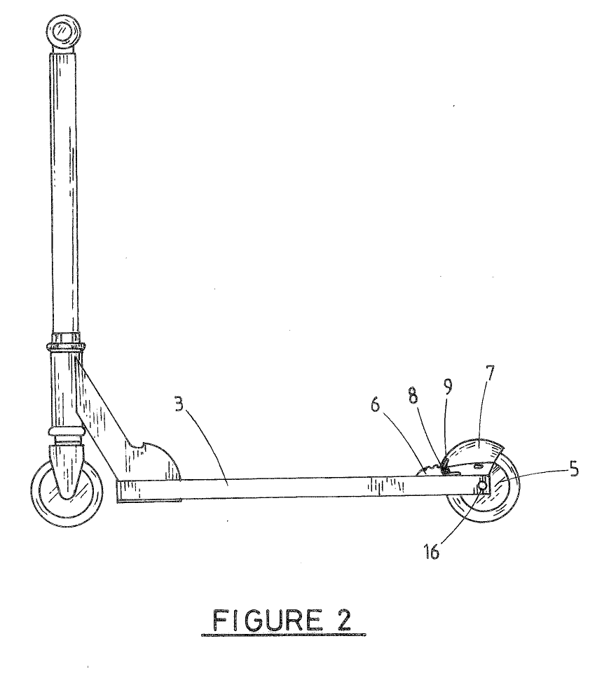

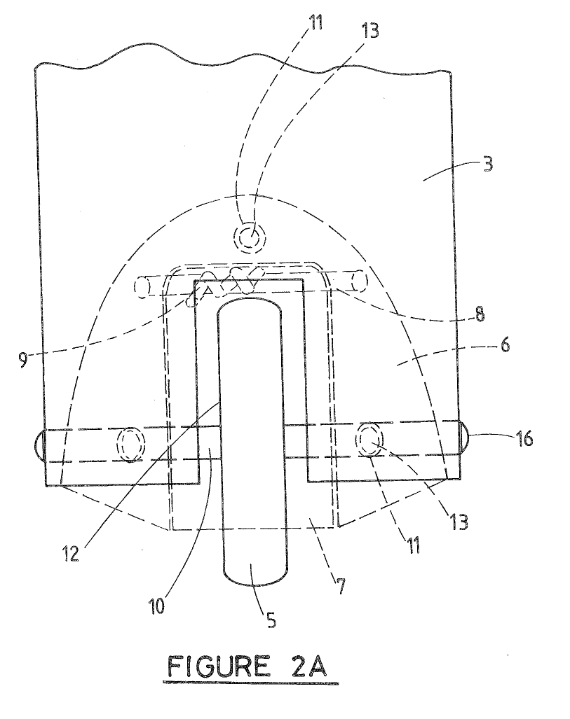

In FIG. 2 and more particularly in FIG. 2a, the wheel assembly is shown. The wheel assembly can be of any known type. In the embodiment illustrated, the wheel assembly includes a wheel 5, a pin or axle 10, and fastening means or device 16. The pin or axle 10 bisects a central aperture in the wheel and is rotatably mounted to the side walls of a scooter deck 3.

In particular, the rear wheel 5 is shown rotatably mounted to inner and outer side walls of the deck 3 by any suitable means, such as an axle or pin arrangement 10. The axle or pin arrangement 10 on which the rear wheel 5 is rotatably mounted bisects a slot 12 at the rear of the deck 3. The pin or axle 10 is rotatably mounted to the side walls of the deck 3 by any suitable fastener or fastening means or device 16, such as a split pin, a rivet, or the like.

The brake housing 6 is mounted to the surface of the deck 3 and supports the wheel cover 7. The main portion of the body of the wheel cover 7 is in a position over the rear wheel 5 of the scooter 1, but not engaging the rear wheel 5 of the scooter 1.

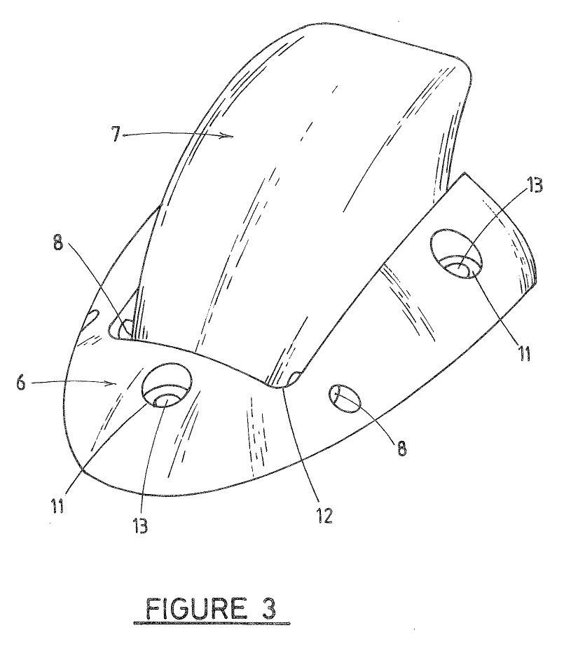

FIG. 3 shows in more detail the brake housing 6 and wheel cover 7 elements. The brake housing 6 may be made of any suitable material, such as metal or a durable polymer. The body of the brake housing 6 has a curved top side and two arms defining a slot in this illustrated embodiment. Also in the embodiment shown, the dimensions of the slot of the brake housing 6 correspond with the slot 12 at the rear of the deck 3.

The arcuate shape of the brake housing 6 also serves as a useful guide to lead a rider's foot to the wheel cover 7.

The brake housing 6 is connected to the rear of the surface of the deck 3, adjacent the slot 12. In the embodiment shown, the brake housing 6 includes apertures 11, which correspond to matching apertures in the top surface of the deck 3. Fasteners 13 fit through corresponding apertures 11 to secure the brake housing 6 to the top of the deck 3. The fasteners 13 may be a nut and bolt, a rivet, or any other suitable fastening means. The brake housing 6 sits proud around the perimeter edges of the slot 12.

The wheel cover 7 includes a substantially hollow arcuate body, similar in shape to a semi-circular mud guard. The wheel cover 7 includes attaching means, which may include an aperture on either side of the body, for mounting the wheel cover 7 to the brake housing 6. The wheel cover 7 may be made of any suitable material, such as metal or a durable polymer. When the wheel cover 7 is mounted to the brake housing 6, the body of the wheel cover 7 sits substantially over the top of the rear wheel 5 in such a manner as not to interfere with the rotation of the rear wheel 5.

In various embodiments, the wheel cover may advantageously serve to prevent or inhibit mud and spray from soiling a rider's legs and clothing.

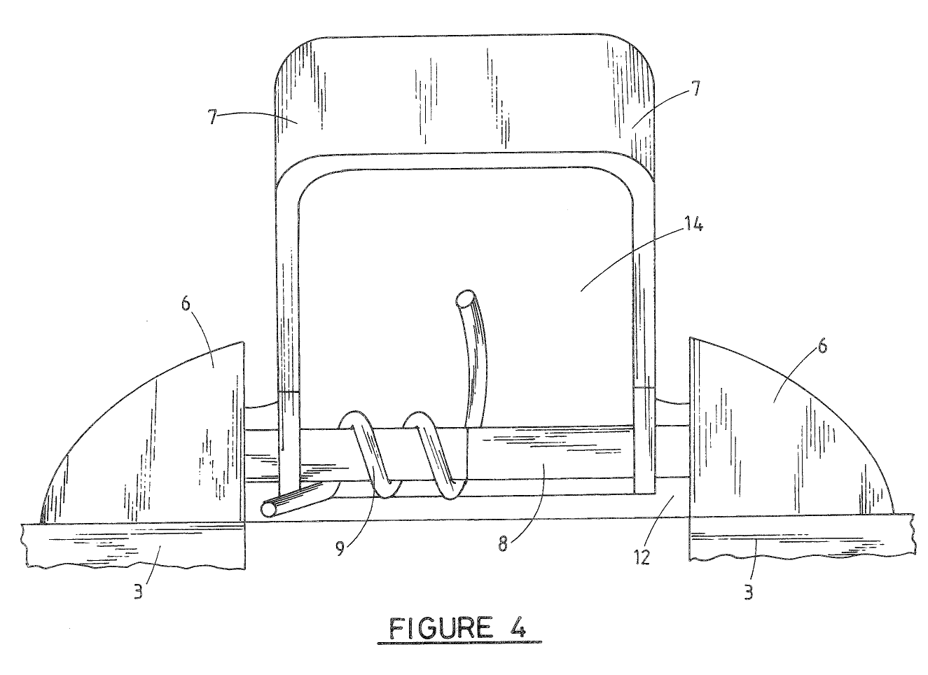

Turning now to FIG. 4, the internal components of the brake assembly are shown. The housing 6 is mounted on the surface of the deck 3. The wheel cover 7 is rotatably mounted on a shaft or pivot pin 8. The shaft or pivot pin 8 may be made of any suitable material, such as metal. The shaft or pivot pin 8 bisects the slot between the arms of the brake housing 6. Each end of the shaft or pivot pin 8 is mounted to the internal side of the arms by suitable means, such as a rivet, nut and bolt, a locking pin, or the like. As can been seen from FIG. 4, the shaft or pivot pin 8 bearing the wheel cover 7 is positioned and operable above the top surface of the deck 3. FIG. 4 also shows that all of the component parts of the braking means are positioned above the top surface of the deck 3.

A biasing means, device, or elastic member 9, which may be a spring, etc., is mounted on the shaft or pivot pin 8 and urges against the inside wall 14 of the wheel cover 7 to keep the wheel cover 7 clear of the rim of the rear wheel 5. Therefore, the wheel cover 7 is kept away from the rear wheel 5 in an at rest position and when no braking is required. A torsion spring is shown, but it is envisaged that any other suitable biasing means, device, or elastic member may be used.

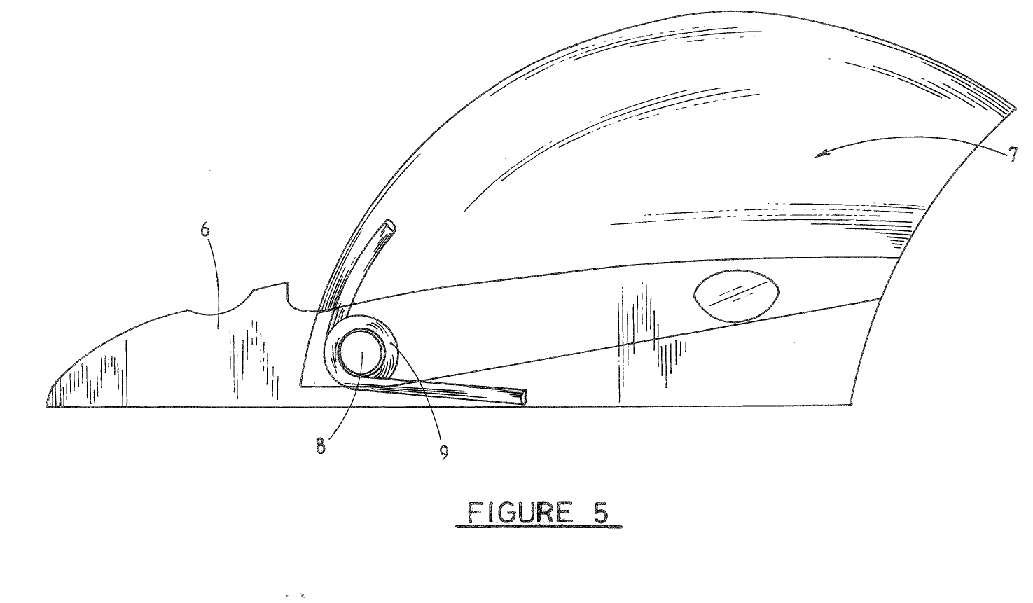

FIG. 5 is a side view of the features of FIG. 4 and shows more clearly the biasing means 9 urging the wheel cover 7 away from the rear wheel 5.

In use, a rider has at least one foot on the deck 3 and can either pump the ground to urge the scooter forward or rest both feet on the top of the deck 3, usually with one foot behind the other, allowing the scooter wheels 4, 5 to propel the scooter 1 forward.

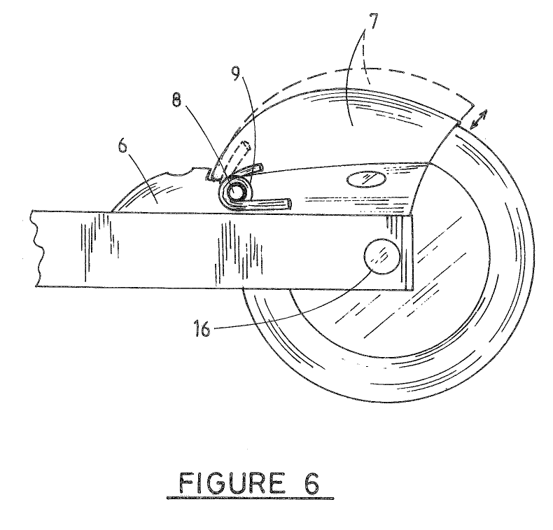

As shown in FIG. 6, when the rider wishes to slow or stop the scooter 1, the rider can optionally use the arcuate shape of the brake housing 6 to guide the rider's foot to the top of the wheel cover 7. The rider depresses the top of the wheel cover 7 by pressing the top of the wheel cover 7 with a foot. The wheel cover 7 will then rotate about the pin 8 and engage the top of the rear wheel 5. Depending on the amount of force applied to the top of the wheel cover 7 by the rider, the friction on the rear wheel 5 by the wheel cover 7 will either slow or stop the scooter 1. Once the scooter 1 has slowed to the desired speed or has stopped, the rider can release the foot from the wheel cover 7 and the wheel cover 7 will rotatably bias back to its separated position over the wheel 5.

In various embodiments, an advantage of the brake system is that the component parts may be inexpensive to manufacture and construct. Furthermore, only a small number of component parts may be required to provide an efficient brake in various embodiments.

A further advantage of the brake assembly in various embodiments is that because the component parts of the brake system are all above deck level, maintenance (such as tightening screws or the like) can readily be made without having to disassemble the scooter.

Additionally, the contours of the brake housing in various embodiments may serve to provide a guide for a rider's foot to lead the foot smoothly onto the wheel cover to apply the brake.

Where in the foregoing description reference has been made to specific components or integers of the disclosure having known equivalents then such equivalents are herein incorporated as if individually set forth. Although this disclosure has been described by way of example and with reference to possible embodiments thereof, it is to be understood that modifications or improvements may be made thereto without departing from the scope of the disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A brake assembly for a non-motorized mobile apparatus including:
one or more wheel assemblies;
a housing mounted on an upper surface of at least a portion of the mobile apparatus, adjacent the one or each wheel assemblies;
one or each housing adapted to support a rotatable braking means including biasing means adjacent at least one wheel;
whereby, in a first position the rotatable braking means being biased away from the at least one wheel, and in a second position the rotatable braking means being biased to engage a surface of at least one wheel to slow or stop the mobile apparatus.

2. The brake assembly as claimed in claim 1 for a non-motorized scooter.

3. The brake assembly as claimed in claim 1 wherein the one or each housing is mounted above the top of a deck of the non-motorized mobile apparatus.

4. The brake assembly as claimed in claim 3 wherein the one or each housing is attached to the top surface of the deck of the non-motorized mobile apparatus by screwing means.

5. The brake assembly as claimed in claim 1 wherein a body of the rotatable braking means is positioned substantially over a top portion of the at least one wheel.

6. The brake assembly as claimed in claim 2 wherein a body of the rotatable braking means is positioned substantially over a top portion of the at least one wheel.

7. The brake assembly as claimed in claim 1 wherein the rotatable braking means is arcuate in shape.

8. The brake assembly as claimed in claim 1 wherein the rotatable braking means is in the shape of a substantially semi-circular mud guard.

9. The brake assembly as claimed in claim 1 wherein the rotatable braking means is attached to the housing by pivoting means.

10. The brake assembly as claimed in claim 9 wherein the rotatable braking means and the pivoting means are located above the upper surface of at least a portion of the mobile apparatus.

11. The brake assembly as claimed in claim 9 wherein the housing includes a U-shaped slot.

12. The brake assembly as claimed in claim 11 wherein the U-shaped slot is adapted to receive the pivoting means biased across the U-shaped slot.

13. The brake assembly as claimed in claim 12 wherein the pivoting means is biased across the U-shaped slot in the housing.

14. The brake assembly as claimed in claim 9 wherein the pivoting means includes a pivot pin or axle.

15. The brake assembly as claimed in claim 9 wherein the biasing means is fixedly attached to the pivoting means.

16. The brake assembly as claimed in claim 1 wherein the biasing means abuts the rotatable braking means to urge the rotatable braking means away from a rim or edge of the at least one wheel.

17. The brake assembly as claimed in claim 1 wherein the biasing means is a spring or an elastic member.

18. The brake assembly as claimed in claim 1 wherein the biasing means is a torsion spring.
